(19) United States
(12) Patent Application Publication
(10) Pub. No.: US 2005/0044790 A1
(43) Pub. Date: Mar. 3, 2005

(54) Natural stone planter with hidden drain reservoir

(76) Inventor: Willfred Allen Schlicker, Startup, WA (US)

Correspondence Address: WILLFRED A. SCHLICKER, PO BOX 333, STARTUP, WA, 98293, US

(21) Appl. No.: 10/650,069

(22) Filed: Aug. 26, 2003

(51) Int. Cl. A01G 9/02; A01G 9/04

(52) U.S. Cl. 47/65.6; 47/71

(57) ABSTRACT

A planter of which the base and plant receptacle are made from one single stone and when assembled maintain the outward appearance and integrity of the original natural stone, said plant receptacle portion being slightly elevated above the base, thereby allowing air flow between the base and plant receptacle

### BACKGROUND OF THE INVENTION

1. Field of the Invention

The present invention relates to planters and particularly to a planter of which the base and plant receptacle are made from a single stone and when assembled retain the integrity of the stone's original form and outward appearance of the original natural stone; said base having spacers for elevating the plant receptacle slightly and also having a depression in the center thereof for holding water, which depression will not hold the bottom of the upper plant receptacle; said plant receptacle having a water directing device on the exterior bottom planar portion thereof and being slightly elevated above the base and, thereby allowing air flow between the base and the plant receptacle.

2. Description of the Prior Art

Planters are well known, most of which comprise a plant receptacle of a smaller circumference which sits inside of a dish-type base with a larger circumference, as seen in prior art U.S. Pat. No. 6,219,967, issued Apr. 24, 2001 to Powell. When the plant is over-watered, the water drains through a hole provided in the bottom of the plant receptacle and pools in the dish of the base. The dirt inside the plant receptacle then remains saturated until the water in the base evaporates. Many plants cannot survive in such a saturated environment and succumb to root rot or failure.

Planters are commonly fabricated from many different materials, such as clay, wood, concrete or plastic. Planters have also been made from stone, which are shown in the following prior art patents.

Prior art U.S. Pat. No. 6,421,955, issued Jul. 23, 2002 to Wilson, relates a rock arrangement having a plurality of foliage. The foliage may include flowers, plants, and feathers. Each of the plurality of foliage includes a stem. A rigid polystyrene material is formed and affixed to a portion of the rock. In addition, a segment of moss material is affixed to a top portion of the rigid polystyrene material. Each stem of the foliage is embedded into the polystyrene material. The moss is used to conceal the polystyrene material, thereby providing an appearance of the plurality of foliage growing from the rock.

Prior art U.S. Pat. No. 6,219,967, issued Apr. 24, 2001 to Powell, illustrates a rock planter apparatus that includes a receptacle made from rock material. The receptacle includes a top receptacle portion and a bottom receptacle portion. A plant-reception well opens at the top receptacle portion and extends downward toward the bottom receptacle portion. The plant-reception well has a well diameter. A drainage channel extends from a bottom portion of the plant-reception well through the bottom receptacle portion. The drainage channel has a channel diameter, and the well diameter is greater than the channel diameter. Preferably, the receptacle is made from natural rock material. The plant-reception well can be cylindrical in shape, and the drainage channel can also be cylindrical in shape. The rock planter apparatus of the invention can be used for receiving plants directly or for receiving potted plants. A base member can be provided upon which the receptacle can be placed. The base member can include a drainage bevel in registration with the drainage channel of the receptacle. A second plant-reception well is provided in the receptacle. The second plant-reception well opens at the top receptacle portion and extending downward toward the bottom receptacle portion. The second plant-reception well has a second well diameter. A second drainage channel extends from a bottom portion of the second plant-reception well through the bottom receptacle portion. The second drainage channel has a second channel diameter, and the second well diameter is greater than the second channel diameter.

Japanese prior art #JP 2001069857 A, issued in March 2001, depicts a planter made from an imitation rock made to resemble a natural stone, which has a plurality of plant holding cavities.

Japanese prior art #JP2002-223639, issued in August 2002, concerns a method of cutting stones into a planter having a modified cubical shape.

The provided prior art patents use a natural stone or stone replica, but none have an upper plant receptacle and a lower base carved from the same single stone while keeping the outward appearance of the external surface intact, thereby maintaining the integrity of the exterior natural surface of the original stone when the two halves are assembled, allowing the finished planter to have the outward appearance of the original natural stone. None of the prior art patents provide an elevated upper plant receptacle that allows air flow between the upper and lower portions of the planter, or provide a water directing device on the bottom of the plant receptacle for directing the drainage water to the depression in the base.

There is a need for an aesthetically pleasing planter wherein the plant receptacle and base are made entirely from one single stone, in which the integrity of the exterior surface and outward appearance of the original natural stone is maintained. There is also a need for a planter made from a single stone that does not hold the bottom plant receptacle inside its drained water depression, and which has a plurality of spacers adhered to or formed on the uppermost surface of the base for supporting the plant receptacle in a slightly elevated fashion above the base for allowing air flow between the plant receptacle and the base, thereby preventing plants from dying from root failure caused by over-watering.

### SUMMARY OF THE INVENTION

An object of the present invention is to provide a planter, of which all parts are cut from the same single stone, thereby maintaining the integrity of the exterior surface and outward appearance of the original natural stone.

A further object of the present invention is to provide a natural stone planter comprising two parts, an upper plant receptacle and a lower base for supporting the upper plant receptacle.

An additional object of the present invention is to provide a natural stone planter having a base with a depression cut into its upper surface for holding excess drained water, but which depression does not cup the bottom of the plant receptacle.

Another object of the present invention is to provide a natural stone planter having an upper portion of which is formed into a plant receptacle comprising one or more plant holding cavities each having at least one drainage hole, the exterior bottom of said plant receptacle is a planar surface that has a water directing device such as an indentation or protrusion surrounding the drainage hole(s), said water directing device preventing the water that has drained from the plant receptacle, from traveling along the bottom exterior planar surface to the outer edge of the planter and instead, directing the drained water to the depression in the base below.

One more object of the present invention is to provide a natural stone planter having a plurality of spacers adhered to or formed on the uppermost surface of the base for supporting the plant receptacle in a slightly elevated fashion above the base for allowing air flow between the plant receptacle and the base, thereby preventing plants from dying from root failure caused by over-watering.

In brief, a planter having a plant receptacle and a base made from the same single stone, thereby maintaining the integrity of the exterior surface and appearance of the original natural stone when the parts are assembled. The single natural stone is cut in two on a horizontal plane, thereby forming two portions. The lower portion of the original stone is formed into the planter base. The base supports the upper plant receptacle portion and has a depression cut into its upper surface for holding excess drained water, but which depression does not cup the bottom of the plant receptacle. The upper portion of the original stone is formed into a plant receptacle having at least one plant holding cavity with at least one drainage hole. The exterior bottom of the plant receptacle is a planar surface that has a water directing indentation or protrusion in a concentric circle surrounding the drainage hole or encircling a plurality of drainage holes. The water directing device prevents the water that has drained from the plant receptacle from traveling along the bottom exterior planar surface to the outer edge of the planter and instead, since water cannot travel up into the groove or up the backside of a protrusion, directs the drained water to the depression in the base below.

Spacers are adhered to the uppermost surface of the base for supporting the plant receptacle in a slightly elevated fashion above the base for allowing air flow between the plant receptacle and the base, thereby preventing plants from dying from root rot or failure caused by over-watering.

An advantage of the present invention is that it is made from just one stone.

A further advantage of the present invention is that it maintains the outward appearance and structure of the original stone.

Another advantage of the present invention is that it is aesthetically pleasing.

An additional advantage of the present invention is that it prevents root rot or failure in plants susceptible to over-watering.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a front perspective view of the present invention showing an initial cut to the base of the original stone.

FIG. 2 is a front perspective view of the present invention showing a secondary cut to the original stone.

FIG. 3 illustrates the present invention having the drain reservoir cut into the lower base.

FIG. 4 illustrates the present invention with the plant holding cavity drilled into the upper plant receptacle.

FIG. 5 illustrates the present invention with a small drainage hole fully drilled through the bottom of the plant receptacle.

### BEST MODE FOR CARRYING OUT THE INVENTION

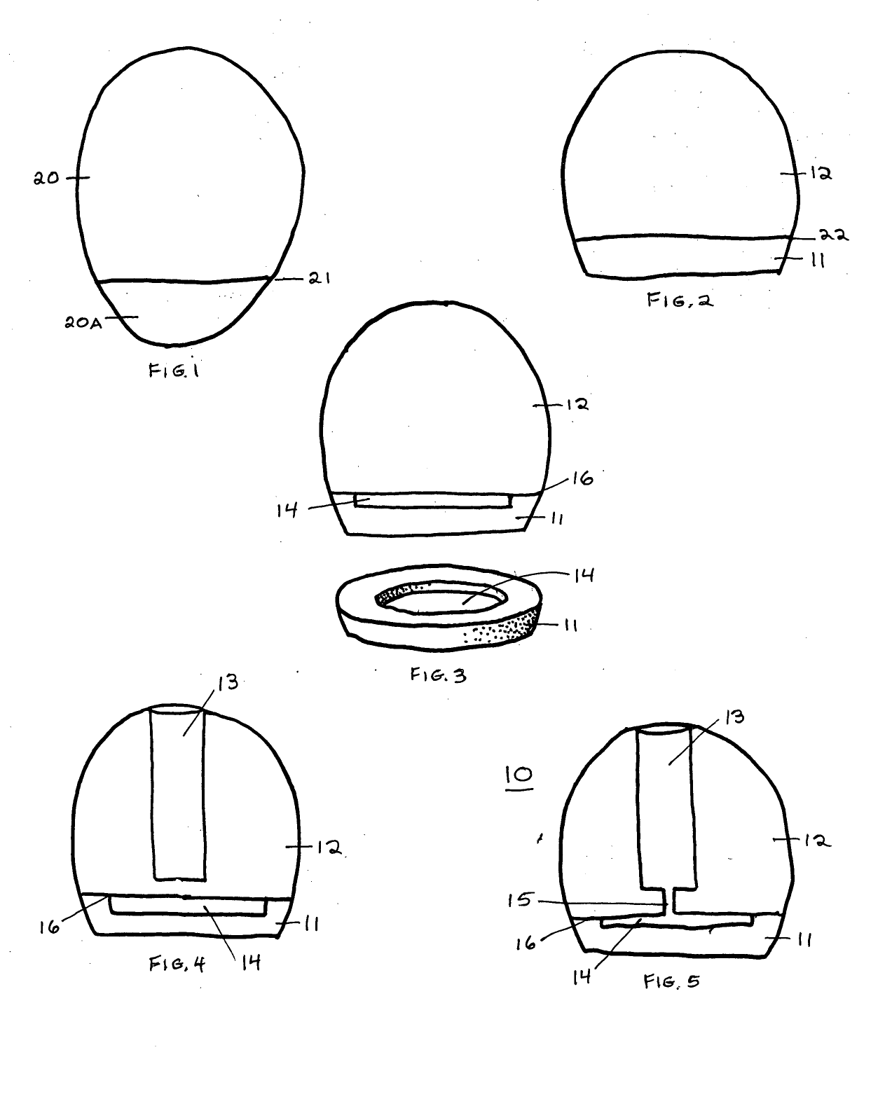

In FIGS. 1-5, a planter 10 of which the plant receptacle 12 and the base 11 are cut from the same single stone 20 thereby maintaining the exterior surface and appearance of the natural stone 20. The natural stone planter 10 comprises two parts, an upper plant receptacle 12 and a lower base 11 for supporting the upper plant receptacle 12. The lower portion of the original stone 20 is formed into the base 11. The base 11 has a depression 14 cut into its upper surface to form a reservoir 14 for holding excess drained water, but which depression 14 does not cup the bottom of the plant receptacle 12.

The upper portion of the original stone 20 is formed into a plant receptacle 12, the exterior bottom of which is a planar surface, formed from the secondary cut 22 illustrated in FIG. 2. The bottom planar surface of the plant receptacle 12 has a water directing device (not shown) preferably comprising an indentation, or alternately comprising a protrusion, which encircles the drainage hole 15 or encircles a plurality of drainage holes 15. Said water directing device prevents the water that has drained from the plant receptacle 12, from traveling along the bottom exterior planar surface to the outer edge of the planter 10 and instead, directing the drained water to the depression 14 in the base 11 below.

A plurality of spacers (not shown) are preferably adhered to the uppermost surface of the base 11 for supporting the plant receptacle 12 in a slightly elevated fashion above the base 11 for allowing air flow space 16 between the plant receptacle 12 and the base 11, thereby preventing plants from dying from root failure or rot caused by over-watering.

In practice, the bottom 20A of the single natural stone 20 is first cut on a horizontal plane 21, as illustrated in FIG. 1, to form a flat bottom for the base 11 of the planter 10. The bottom piece of the stone 20A is then discarded. The stone 20 is then cut a second time on a horizontal plane 22, as shown in FIG. 2, forming a lower slab 11 preferably 2-inches thick from the bottom of the stone 20. The 2-inch thick slab 11 is used to form the base 11 of the planter 10. A slight depression 14 or reservoir 14 for holding drained water is cut out in the center of the upper planar surface of the base 11, as seen in FIG. 3. A plurality of spacers (not shown) are preferably adhered to the upper planar surface of the base 11 between the edge of the cut depression 14 and the outer edge of the base 11. Enough spacers are to be used so that the plant receptacle 12 is balanced and supported when placed atop the spacers. The spacers may be made from various substances such as plastic, wood, metal or felt. In the present invention 10 plastic bumpers having a pre-applied adhesive on the back, which are commonly found at hardware store, where used. Alternately, the spacers could be formed or cut from the base 11. The spacers may be of a thickness between 1/32 of an inch and any thickness which creates an air flow space 16 that does not interfere with or detract from the aesthetic outward appearance of the natural stone planter 10, however all spacers on an individual planter 10 must be of the same thickness for proper support and balance of the plant receptacle 12.

The upper portion of the stone 20 is used to form a plant receptacle 12. A plant holding cavity 13 is drilled in the top of the plant receptacle 12, as seen in FIG. 4. A drainage hole 15 is then drilled fully through the bottom of the plant holding cavity 13, as illustrated in FIG. 5.

Preferably, a groove or indentation (not shown) is cut into the exterior planar bottom of the plant receptacle 12, said indentation encircles the drainage hole 15, for the purpose of directing the drained water to the depression 14 in the base 11 below. Alternately, a protrusion (not shown) may be adhered to or formed as part of the exterior planar bottom of the plant receptacle 12, said protrusion encircles the drainage hole 15, for the same purpose of directing the drainage water to the depression 14 in the base 11 below.

To assemble the planter 10 after potting a plant in the plant holding cavity 13 of the upper plant receptacle 12, the planar bottom surface of the upper plant receptacle 12 is seated atop the spacers that are adhered to the uppermost surface of the base 11. The outer surfaces of the base 11 and the plant receptacle 12 are then aligned, thereby creating a planter 10 having the aesthetic look of the original exterior of the original single natural stone 20. The original outward appearance of the single original stone is maintained with only a slight gap 16 for airflow between the base 11 and the plant receptacle 12.

The planter 10 may be made having more than one plant holding cavity 13 in the plant receptacle 12, in which case each plant holding cavity 13 has its own drain hole 15 and the water directing device encircles all of the drain holes 15. The plant holding cavity(ies) 13 may be made in any shape. A replica of a natural stone 20 may also be formed from other materials, such as cementitious material or plastics, and then cut to form a planter in the same manner.

It is understood that the preceding description is given merely by way of illustration and not in limitation of the invention and that various modifications may be made thereto without departing from the spirit of the invention as claimed.

1. A planter, of which all parts are cut from the same single stone, thereby maintaining the exterior surface and outward appearance of the original natural stone, said planter comprising:
an upper plant receptacle comprising at least one plant holding cavity having at least one drainage hole drilled through the bottom thereof and an exterior planar bottom surface that has a water directing device comprising an indentation or protrusion that encircles a single drainage hole or encircles a plurality of drainage holes, said water directing device preventing the water that has drained from the drainage hole(s), from traveling along the bottom exterior planar surface to the outer edge of the planter and instead, directing the drained water to the depression in the base below;
a base having an upper planar surface with a depression cut into the center of the upper planar surface for holding excess drained water, but which depression does not cup the bottom of the plant receptacle or reach to the outermost edges of the base;
a plurality of spacers adhered to the uppermost surface of the base, between the edge of the depression in the base and the outermost edge of the base, for supporting the plant receptacle in a slightly elevated fashion above the base for allowing air to flow between the plant receptacle and the base.
